(19) United States
(12) Patent Application Publication
(10) Pub. No.: US 2025/0208384 A1
(43) Pub. Date: Jun. 26, 2025

(54) OPTICAL IMAGING SYSTEM

(71) Applicant: SAMSUNG ELECTRO-MECHANICS CO., LTD., Suwon-si (KR)

(72) Inventors: Tae Yeon LIM, Suwon-si (KR); Byung Gi AN, Suwon-si (KR); Kum Ho KIM, Suwon-si (KR); Yoo Chang KIM, Suwon-si (KR)

(73) Assignee: SAMSUNG ELECTRO-MECHANICS CO., LTD., Suwon-si (KR)

(21) Appl. No.: 18/948,712

(22) Filed: Nov. 15, 2024

(30) Foreign Application Priority Data
Dec. 21, 2023 (KR) 10-2023-0188813
Sep. 12, 2024 (KR) 10-2024-0124995

(51) Int. Cl. G02B 13/00; G02B 9/60; G02B 13/02

(52) U.S. Cl. CPC G02B 13/0065; G02B 9/60; G02B 13/0045; G02B 13/02

(57) ABSTRACT

An optical imaging system includes a first lens group having at least two reflective surfaces and including a first lens and a second lens; a second lens group including a plurality of lenses; and a reflective member disposed between the first lens group and the second lens group, wherein the at least two reflective surfaces include a first reflective surface formed on an image-side surface of the second lens and a second reflective surface formed on an object-side surface of the first lens, the object-side surface of the first lens includes a first refractive surface, the image-side surface of the second lens includes a second refractive surface, and the reflective member includes a third reflective surface, and a conditional expression f1G/fT<0.9 is satisfied, where f1G is a focal length of the first lens group, and IT is a total focal length of the optical imaging system.

### CROSS-REFERENCE TO RELATED APPLICATIONS

This application claims the benefit under 35 USC § 119 (a) of Korean Patent Application No. 10-2023-0188813 filed on Dec. 21, 2023, and Korean Patent Application No. 10-2024-0124995 filed on Sep. 12, 2024, in the Korean Intellectual Property Office, the entire disclosures of which are incorporated herein by reference for all purposes.

### BACKGROUND

### 1. Field

The following description relates to an optical imaging system.

### 2. Description of Related Art

Recent optical imaging systems that are implemented in portable electronic devices typically have a small form factor, and have high-magnification (telephoto) performance.

However, since the optical imaging system with high-magnification telephoto performance must have a long focal length, there is a problem that the size of the optical imaging system inevitably increases.

Accordingly, an optical imaging system that bends light through a reflective member is being proposed.

Additionally, a structure has recently been proposed in which a portion of the lenses of the optical imaging system are disposed in front of the reflective member.

However, even with these typical optical imaging systems, the optical imaging system still has a large size, which limits the installation of high-resolution optical imaging systems in portable electronic devices.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical imaging system includes a first lens group, including a first lens and a second lens arranged along a first optical axis, and having at least two reflective surfaces; a second lens group, comprising a plurality of lenses arranged along a second optical axis, and spaced apart from the first lens group; and a reflective member disposed between the first lens group and the second lens group, wherein the at least two reflective surfaces comprise a first reflective surface disposed on an image-side surface of the second lens, and a second reflective surface disposed on an object-side surface of the first lens, wherein the object-side surface of the first lens comprises a first refractive surface that extends outwardly of the second reflective surface, wherein the image-side surface of the second lens comprises a second refractive surface that is disposed inwardly of the first reflective surface, wherein the reflective member comprises a third reflective surface, and wherein a conditional expression f1G/fT<0.9 is satisfied, where f1G is a focal length of the first lens group, and fT is a total focal length of the optical imaging system.

The first lens group may have positive refractive power, and the second lens group may have negative refractive power.

A conditional expression f1G>0 and Rp<0 may be satisfied, where Rp is a radius of curvature of the first reflective surface of the second lens of the first lens group.

A conditional expression 2 mm<d<3 mm may be satisfied, where d is a distance along the first optical axis from the object-side surface of the first lens of the first lens group to the image-side surface of the second lens of the first lens group.

A conditional expression 0.2<|(2×d)/Rp|<0.6 may be satisfied, where d is a distance along the first optical axis from the object-side surface of the first lens of the first lens group to the image-side surface of the second lens of the first lens group, and Rp is a radius of curvature of the first reflective surface of the second lens of the first lens group.

A conditional expression 0.4<Hs/Hp<0.6 is satisfied, where Hp is an effective diameter of the object-side surface of the first lens of the first lens group, and Hs is an effective diameter of the second reflective surface of the first lens of the first lens group.

The reflective member may further include an incident surface and an exit surface, and the third reflective surface is disposed between the incident surface and the exit surface, and a conditional expression 0.4<d/Ph<0.8 may be satisfied, where d is a distance along the first optical axis from the object-side surface of the first lens of the first lens group to the image-side surface of the second lens of the first lens group, and Ph is a sum of a distance along the first optical axis from the incident surface to the third reflective surface and a distance along the second optical axis from the third reflective surface to the exit surface.

A conditional expression L/fT<0.8 may be satisfied, where L is a sum of a distance along the second optical axis from the third reflective surface to an imaging plane disposed on the second optical axis and an effective radius of the first lens.

A conditional expression 0.5<Rs/Rp<1.3 may be satisfied, where Rs is a radius of curvature of the second reflective surface of the first lens of the first lens group, and Rp is a radius of curvature of the first reflective surface of the second lens of the first lens group.

A conditional expression 1<f1G/Rp<2.3 may be satisfied, where Rp is a radius of curvature of the first reflective surface of the second lens of the first lens group.

A conditional expression 0.1<Lf/fT<0.7 may be satisfied, and Lf is a distance along the first optical axis from the second reflective surface of the first lens of the first lens group to the third reflective surface of the reflective member.

A conditional expression 0.2<Lf/Lr<0.5 may be satisfied, where Lf is a distance along the first optical axis from the second reflective surface of the first lens of the first lens group to the third reflective surface of the reflective member, and Lr is a distance along the second optical axis from the third reflective surface of the reflective member to an imaging plane.

The first lens may have negative refractive power, and the second lens may have positive refractive power.

The plurality of lenses of the second lens group may include a third lens, a fourth lens, and a fifth lens arranged along the second optical axis, and wherein the fifth lens may have positive refractive power.

Other features and aspects will be apparent from the following detailed description, the drawings, and the claims.

### BRIEF DESCRIPTION OF DRAWINGS

FIG. 1 illustrates a configuration diagram of an example optical imaging system, in accordance with a first embodiment.

FIG. 2 illustrates aberration characteristics of the example optical imaging system illustrated in FIG. 1.

FIG. 3 illustrates an example optical imaging system, in accordance with a second embodiment.

FIG. 4 illustrates the aberration characteristics of the example optical imaging system illustrated in FIG. 3.

FIG. 5 illustrates an example optical imaging system in accordance with a third embodiment.

FIG. 6 illustrates the aberration characteristics of the example optical imaging system illustrated in FIG. 5.

FIG. 7 illustrates an example optical imaging system in accordance with one or more embodiments.

FIG. 8 illustrates a plan view of a first lens of an optical imaging system, in accordance with one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In the lens configuration diagram below, a thickness, a size, and a shape of the lens are somewhat exaggerated for explanation purposes, and in particular, a spherical or aspherical shape presented in the lens configuration diagram is only presented as an example and is not limited to this shape.

An optical imaging system, in accordance with one or more embodiments, may be mounted on a portable electronic device. In an example, the optical imaging system may be a component of a camera module mounted on a portable electronic device. Portable electronic devices may be portable electronic devices such as, but not limited to, a mobile communication terminal, a smartphone, a tablet personal computer (PC), etc.

In the one or more examples, numerical values for the lenses such as a radius of curvature, a thickness, a distance, a focal length, etc., are all in mm, and the unit of field of view is degrees.

Additionally, in the description of the shape of each lens, the meaning of a convex shape on one surface means that a paraxial region of that surface is convex, and the meaning of a concave shape on one surface means that the paraxial region of that surface is concave.

In an example, the paraxial region refers to a very narrow region near an optical axis.

An imaging plane may mean a virtual plane on which focus is formed by the optical imaging system. Alternatively, the imaging plane may mean one surface of an image sensor on which light is received.

One or more examples may provide an optical imaging system that implements high resolution while having a small size.

One or more examples may provide an optical imaging system that reduces the size of the optical imaging system and captures high-resolution images.

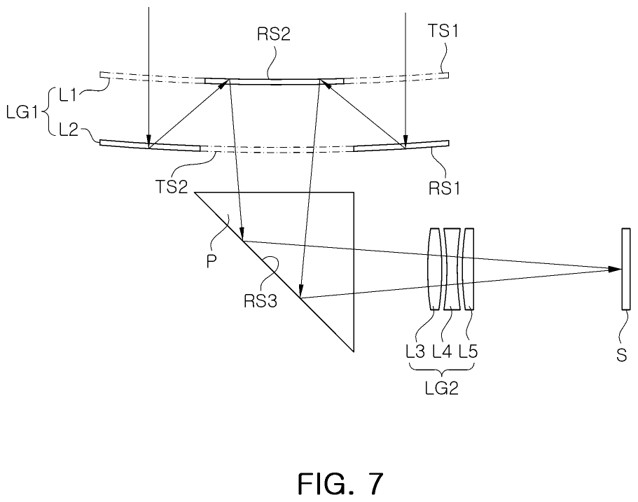

Referring to FIG. 7, an optical imaging system, in accordance with one or more embodiments, includes a plurality of lens groups. For example, the optical imaging system may include a first lens group LG1 and a second lens group LG2.

The first lens group LG1 may include one or more lenses and a plurality of reflective surfaces, and the second lens group LG2 may include a plurality of lenses.

In an embodiment, the first lens group LG1 may include a first lens L1 and a second lens L2, the second lens L2 includes a first reflective surface RS1, and the first lens L1 includes a second reflective surface RS2. The second lens group LG2 may include a third lens L3, a fourth lens L4, and a fifth lens L5.

The first lens L1 and the second lens L2 of the first lens group LG1 may be arranged along a first optical axis, and the third lens L3 to the fifth lens L5 of the second lens group LG2 may be arranged along a second optical axis.

The first optical axis of the first lens group LG1 and the second optical axis of the second lens group LG2 may intersect each other. For example, a virtual line that extends on the first optical axis of the first lens group LG1 and a virtual line that extends on the second optical axis of the second lens group LG2 may intersect each other.

In an embodiment, the first optical axis of the first lens group LG1 and the second optical axis of the second lens group LG2 may be perpendicular to each other.

In a non-limited example, the first lens group LG1 may have a positive refractive power overall, and the second lens group LG2 may have a negative refractive power overall.

An optical imaging system, in accordance with one or more embodiments, may further include a reflective member P that changes a direction of propagation of light. The reflective member P may have a third reflective surface RS3. In an example, the reflective member P may be a mirror or a prism. In an embodiment, the reflective member P may be disposed between the first lens group LG1 and the second lens group LG2.

When the reflective member P is a prism, the reflective member P may have any shape among those obtained by dividing a rectangular solid or a cube into two halves in the diagonal direction. The reflective member P may include an incident surface, a third reflective surface RS3, and an exit surface. The reflective member P may have three rectangular faces and two triangular faces. In an example, the incident surface, the third reflective surface RS3, and the exit surface of the reflective member P may each be rectangular in shape, and both side surfaces of the reflective member P may be approximately triangular in shape.

Light passing through the first lens group LG1 may be incident on the incident surface of the reflective member P, a light incident on the incident surface may be reflected on the third reflective surface RS3, and the light reflected on the third reflective surface RS3 may be emitted to the exit surface.

An optical imaging system, in accordance with one or more embodiments, may form a long optical path in a relatively narrow space by bending light through the reflective member P.

Therefore, the optical imaging system may be miniaturized while allowing the optical imaging system to have a long focal length.

An optical imaging system, in accordance with one or more embodiments, may have the characteristics of a telephoto lens having a relatively narrow angle of view and a long focal length.

An effective diameter of an object-side surface of one or more lenses included in the first lens group LG1 and an effective diameter of an image-side surface of one or more lenses included in the first lens group LG1 may each be greater than a minor axis length of the incident surface of the reflective member P.

In an example, one or more lenses included in the first lens group LG1 may be approximately circular when viewed in the first optical axis direction of the first lens group LG1.

The effective diameters of the object-side surface of a plurality of lenses included in the second lens group LG2 and the effective diameters of the image-side surface of a plurality of lenses included in the second lens group LG2 may each be smaller than the minor axis length of the incident surface of the reflective member.

In an example, the lenses included in the second lens group (LG2) may be approximately circular when viewed from the second optical axis direction of the second lens group LG2.

The optical imaging system may further include an image sensor S that converts an image of the incident subject into an electrical signal.

Additionally, the optical imaging system may further include an infrared blocking filter (hereinafter referred to as “filter”) that blocks infrared rays. The filter may be disposed between a rearmost lens (e.g., the fifth lens L5) and the image sensor S.

The first lens group LG1 may include at least two reflective surfaces. Since the first lens group LG1 includes at least two reflective surfaces, a height of the optical imaging system (e.g., the height in the first optical axis direction) may be reduced while implementing a long overall focal length (i.e., a telephoto lens).

In an embodiment, if the first lens group LG1 includes two lenses (e.g., the first lens L1 and the second lens L2), at least two reflective surfaces may be disposed on a lens (the first lens L1) disposed closest to an object side among the two lenses included in the first lens group LG1 and a lens (the second lens L2) disposed adjacent to the lens disposed closest to an object side.

For example, the first lens L1 and the second lens L2 may each have at least one reflective surface.

At least one reflective surface may be formed on the object-side surface of the first lens L1, and at least one reflective surface may be formed on the image-side surface of the second lens L2.

In an embodiment, a portion of the object-side surface of the first lens L1 may operate as a reflective surface, and a portion of the image-side surface of the second lens L2 may operate as a reflective surface.

Hereinafter, a reflective surface formed on the image-side surface of the second lens L2 is referred to as the first reflective surface RS1, and a reflective surface formed on the object-side surface of the first lens L1 is referred to as the second reflective surface RS2.

The object-side surface of the first lens L1 may include the second reflective surface RS2 and a first refractive surface TS1. In an example, the second reflective surface RS2 may be formed at the center portion of the object-side surface of the first lens L1, and the first refractive surface TS1 may extend from the second reflective surface RS2 to an outside of the second reflective surface RS2. That is, the second reflective surface RS2 may be disposed on an inside of the first refractive surface TS1.

In an example, ‘outside’ may refer to a direction away from the first optical axis, and ‘inside’ may refer to a direction closer to the first optical axis.

Since the second reflective surface RS2 may be formed in the center portion of the object-side surface of the first lens L1, light may be blocked and may not transmit through the center portion of the object-side surface of the first lens L1. Light may pass through the first refractive surface TS1 on the object-side surface of the first lens L1 and enter the second lens L2.

The image-side surface of the second lens L2 may include the first reflective surface RS1 and a second refractive surface TS2. In an example, the second refractive surface TS2 may be formed at the center portion of the image-side surface of the second lens L2, and the first reflective surface RS1 may extend from the second refractive surface TS2 to the outside of the second refractive surface TS2. That is, the first reflective surface RS1 may be disposed on the outside of (or external to) the second refractive surface TS2.

Light passing through the first lens L1 may be reflected by the first reflective surface RS1 on the image-side surface of the second lens L2, and may be directed back toward the first lens L1. Additionally, light reflected by the first reflective surface RS1 toward the first lens L1 may be reflected by the second reflective surface RS2 on the object-side surface of the first lens L1, and pass through the second lens L2 toward the reflective member P.

Light passing through the second lens L2 may be reflected by the third reflective surface RS3 of the reflective member P, and may enter the second lens group LG2.

In an embodiment, one or more lenses included in the first lens group LG1 and a plurality of lenses included in the second lens group LG2 may each have an aspherical object-side surface and an image-side surface.

The aspherical surface of the lens is expressed by Equation 1 below.

$$Z = \qquad Equation 1$$

$$\frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14}$$

In Equation 1, c represents a curvature of the lens surface (the reciprocal of the radius of curvature), K represents a conic constant, and Y represents a distance from any point on an aspherical surface of the lens to the optical axis. Additionally, constants A to F represent aspheric coefficients. Moreover, Z (SAG) represents a distance along the optical axis from any point on the aspheric surface of the lens to a vertex of the corresponding aspheric surface.

An optical imaging system, in accordance with one or more embodiments, may satisfy at least one of the following conditional expressions.

In an embodiment, the optical imaging system may satisfy the condition f1G>0 and Rp<0. In an example, f1G is a total focal length of the first lens group LG1, and Rp is a radius of curvature of the first reflective surface RS1 of the second lens of the first lens group LG1. For example, the first reflective surface RS1 of the first lens group LG1 may have a concave shape when viewed from the object side. That is, the first reflective surface RS1 of the first lens group LG1 may have a shape that is convex toward the image side.

Therefore, image brightness may be improved and resolution may be enhanced.

In an embodiment, the optical imaging system may satisfy the condition 2 mm<d<3 mm. In an example, d is a distance along the first optical axis from the object-side surface of the first lens L1 to the image-side surface of the second lens L2. Therefore, the optical imaging system may be miniaturized.

In an embodiment, the optical imaging system may satisfy the condition |(2×d)/Rp|>0.4. Alternatively, the optical imaging system may satisfy the condition 0.2<|(2×d)/Rp|<0.6.

Therefore, image brightness may be improved and resolution may be enhanced.

In an embodiment, the optical imaging system may satisfy the condition 0.4<Hs/Hp<0.6. In an example, Hp is an effective diameter of the object-side surface of the first lens L1, and Hs is an effective diameter of the second reflective surface RS2 of the first lens L1. Therefore, the image brightness may be improved and the resolution may be enhanced.

In an embodiment, the optical imaging system may satisfy the condition f1G/fT<0.9. In an example, fT is a total focal length of the optical imaging system. Therefore, the optical imaging system may be miniaturized.

In an embodiment, the optical imaging system may satisfy the condition 0.4<d/Ph<0.8. In an example, Ph is a sum of a distance along the first optical axis from the incident surface of the reflective member P to the third reflective surface RS3 and a distance along the second optical axis from the third reflective surface RS3 of the reflective member P to the exit surface.

Therefore, the optical imaging system may be miniaturized.

In an embodiment, the optical imaging system may satisfy the condition L/fT<0.8. In an example, L is a total track length along the second optical axis of the optical imaging system. For example, L may represent a distance along the second optical axis from the effective diameter end of the first lens group LG1 in the second optical axis direction to the imaging plane. Alternatively, L may represent a sum of the distance along the second optical axis from the third reflective surface RS3 of the reflective member P to the imaging plane and an effective radius of the first lens L1.

Therefore, the optical imaging system may be miniaturized.

In an embodiment, the optical imaging system may satisfy the condition 0.5<Rs/Rp<1.3. In an example, Rs is a radius of curvature of the second reflective surface RS2 of the first lens group LG1. For example, the second reflective surface RS2 of the first lens group LG1 may have a concave shape. Therefore, the resolution may be improved.

In an embodiment, the optical imaging system may satisfy the condition 1<f1G/Rp<2.3. Accordingly, the resolution may be improved.

In an embodiment, the optical imaging system may satisfy the condition 0.1<Lf/fT<0.7. In an example, Lf is a distance along the first optical axis from the second reflective surface RS2 of the first lens group LG1 to the third reflective surface RS3 of the reflective member P. Therefore, the optical imaging system may be miniaturized.

In an embodiment, the optical imaging system may satisfy the condition 0.2<Lf/Lr<0.5. In an example, Lr is a distance along the second optical axis from the third reflective surface RS3 of the reflective member P to the imaging plane. Accordingly, the optical imaging system may be miniaturized.

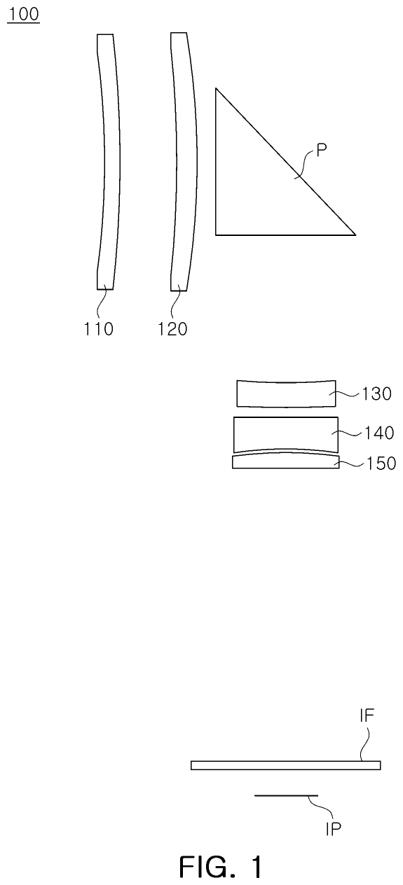

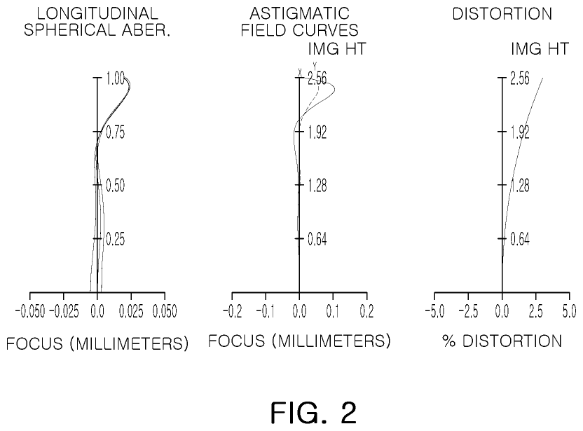

An example optical imaging system 100, in accordance with a first embodiment, will be described with reference to FIGS. 1 and 2.

An example optical imaging system 100, in accordance with one or more embodiments, includes a first lens group LG1 and a second lens group LG2. Additionally, the optical imaging system includes a reflective member P disposed between the first lens group LG1 and the second lens group LG2.

In order from the object side to the imaging plane, the first lens group LG1 includes a first lens 110 and a second lens 120, and the second lens group LG2 includes a third lens 130, a fourth lens 140, and a fifth lens 150.

Additionally, the optical imaging system may further include a filter IF and an image sensor.

The optical imaging system 100 according to the first embodiment may form a focus on an imaging plane IP. The imaging plane IP may refer to a surface on which focus may be formed by the optical imaging system. For example, the imaging plane IP may refer to one surface of the image sensor receiving light.

In the first embodiment, the reflective member P may be a prism. However, this is only an example, and the reflective member P may also be provided as a mirror.

Lens characteristics of each lens (a radius of curvature, a thickness of a lens or a distance between lenses, a refractive index, an Abbe number, or an effective radius) are illustrated in Table 1 below.

In the tables below, the ‘−’ sign for thickness or distance is due to light reflection.

TABLE 1

| | | | | Thickness | | | |
|---|---|---|---|---|---|---|---|
| | Lens | | Curvature | or | Refractive | Abbe | Effective |
| Component | surface | Surface No. | Radius | Distance | Index | No. | Radius |
| 1st Lens | L1S1 | S1 | −24.330 | 0.453 | 1.535 | 55.7 | 3.150 |
| | L1S2 | S2 | −29.818 | 1.615 | | | 3.150 |
| 2nd Lens | L2S1 | S3 | −31.959 | 0.575 | 1.535 | 55.7 | 3.180 |
| | L2S2_R1 | S4 (reflection) | −21.699 | −0.575 | | | 3.190 |
| | L2S1 | S5 | −31.959 | −1.615 | | | 3.053 |
| 1st Lens | L1S2 | S6 | −29.818 | −0.453 | 1.535 | 55.7 | 2.510 |
| | L1S1_R2 | S7 (reflection) | −24.330 | 0.453 | | | 2.394 |
| | L1S2 | S8 | −29.818 | 1.615 | | | 2.371 |
| 2nd Lens | L2S1 | S9 | −31.959 | 0.575 | 1.535 | 55.7 | 2.180 |
| | L2S2 | S10 | −21.699 | 0.557 | | | 2.152 |
| Prism | PS1 | S11 | Infinity | 2.000 | 1.717 | 29.5 | 4.000 |
| | PS2 | S12(reflection) | Infinity | −2.000 | 1.717 | 29.5 | 4.000 |
| | PS3 | S13 | Infinity | −4.000 | | | 4.000 |
| 3rd Lens | L3S1 | S14 | −13.731 | −0.700 | 1.544 | 56.0 | 1.220 |
| | L3S2 | S15 | −15.268 | −0.252 | | | 1.278 |
| 4th Lens | L4S1 | S16 | −50.806 | −0.861 | 1.639 | 23.5 | 1.307 |
| | L4S2 | S17 | 9.894 | −0.105 | | | 1.359 |
| 5th Lens | L5S1 | S18 | 10.501 | −0.400 | 1.639 | 23.5 | 1.377 |
| | L5S2 | S19 | −164.006 | −8.000 | | | 1.394 |
| Filter | | S20 | Infinity | −0.210 | 1.5168 | 64.2 | |
| | | S21 | Infinity | −0.721 | | | |
| Imaging | | S22 | Infinity | | | | |
| plane | | | | | | | |

The value listed as the effective radius of the prism in Table 1 refers the value of the major axis effective radius. In the first embodiment, the minor axis effective radius of the incident surface of the prism is 2 mm.

In the first embodiment, the first lens group LG1 may have an overall positive refractive power, and the second lens group LG2 may have an overall negative refractive power.

The first lens 110 may have negative refractive power, an object-side surface of the first lens 110 may have a concave shape, and an image-side surface of the first lens 110 may have a convex shape.

The second lens 120 may have positive refractive power, an object-side surface of the second lens 120 may have a concave shape, and an image-side surface of the second lens 120 may have a convex shape.

The third lens 130 may have negative refractive power, an object-side surface of the third lens 130 may have a concave shape, and an image-side surface of the third lens 130 may have a convex shape.

The fourth lens 140 may have negative refractive power, and an object-side surface and an image-side surface of the fourth lens 140 may be concave in shape.

The fifth lens 150 may have positive refractive power, and an object-side surface and an image-side surface of the fifth lens 150 may be convex in shape.

In an example, each surface of the first lens 110 to the fifth lens 150 may have an aspherical coefficient as illustrated in Table 2 below. In an example, the object-side surface and the image-side surface of each of the first lens 110 to the fifth lens 150 are aspherical.

TABLE 2

| | S1 | S2 | S3 | S4 | S5 | S6 | S7 | S8 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| constant | | | | | | | | |
| (K) | | | | | | | | |
| 4th | 5.102E−07 | 8.875E−06 | −7.285E−06 | 4.707E−06 | −7.285E−06 | 8.875E−06 | 5.102E−07 | 8.875E−06 |
| coefficient | | | | | | | | |
| (A) | | | | | | | | |
| 6th | 5.014E−07 | 2.669E−07 | 6.062E−08 | 7.728E−08 | 6.062E−08 | 2.669E−07 | 5.014E−07 | 2.669E−07 |
| coefficient | | | | | | | | |
| (B) | | | | | | | | |
| 8th | 1.288E−08 | 3.083E−08 | 1.403E−08 | 1.027E−09 | 1.403E−08 | 3.083E−08 | 1.288E−08 | 3.083E−08 |
| coefficient | | | | | | | | |
| (C) | | | | | | | | |
| 10th | 5.886E−10 | 2.096E−09 | −1.235E−09 | 3.890E−10 | −1.235E−09 | 2.096E−09 | 5.886E−10 | 2.096E−09 |
| coefficient | | | | | | | | |
| (D) | | | | | | | | |
| 12th | 2.948E−11 | −3.000E−10 | −3.410E−11 | −4.932E−11 | −3.410E−11 | −3.000E−10 | 2.948E−11 | −3.000E−10 |
| coefficient | | | | | | | | |
| (E) | | | | | | | | |
| 14th | −2.954E−12 | 2.401E−12 | −7.171E−12 | 4.254E−13 | −7.171E−12 | 2.401E−12 | −2.954E−12 | 2.401E−12 |
| coefficient | | | | | | | | |
| (F) | | | | | | | | |

| | S9 | S10 | S14 | S15 | S16 | S17 | S18 | S19 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| constant | | | | | | | | |
| (K) | | | | | | | | |
| 4th | −7.285E−06 | 4.707E−06 | 1.451E−03 | −1.704E−03 | 1.028E−03 | 3.969E−04 | −1.730E−03 | 1.703E−03 |
| coefficient | | | | | | | | |
| (A) | | | | | | | | |
| 6th | 6.062E−08 | 7.728E−08 | −3.235E−05 | −1.408E−04 | 3.579E−04 | −3.569E−04 | −1.852E−04 | 6.399E−04 |
| coefficient | | | | | | | | |
| (B) | | | | | | | | |
| 8th | 1.403E−08 | 1.027E−09 | −2.103E−04 | 2.549E−04 | 4.084E−05 | −1.955E−04 | 6.586E−05 | 1.303E−04 |
| coefficient | | | | | | | | |
| (C) | | | | | | | | |
| 10th | −1.235E−09 | 3.890E−10 | 5.275E−05 | 1.146E−04 | 7.653E−05 | −1.000E−04 | 1.032E−04 | −9.924E−06 |
| coefficient | | | | | | | | |
| (D) | | | | | | | | |
| 12th | −3.410E−11 | −4.932E−11 | 8.039E−05 | 1.170E−04 | 5.948E−05 | 6.330E−05 | 0.000E+00 | 6.629E−05 |
| coefficient | | | | | | | | |
| (E) | | | | | | | | |
| 14th | −7.171E−12 | 4.254E−13 | 0.000E+00 | 0.000E+00 | 0.000E+00 | 0.000E+00 | 0.000E+00 | −1.717E−05 |
| coefficient | | | | | | | | |
| (F) | | | | | | | | |

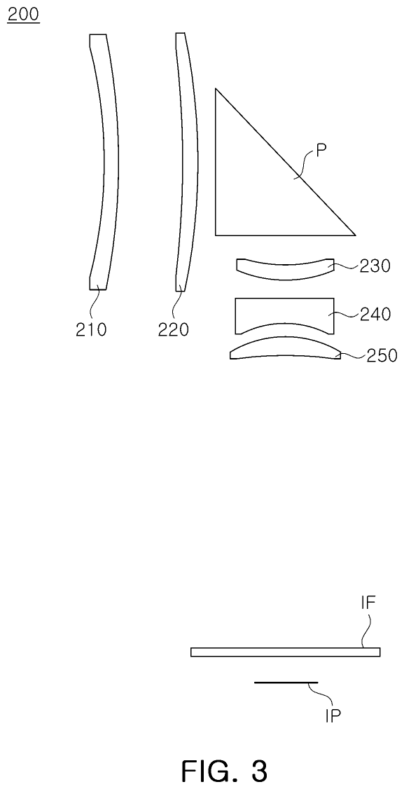

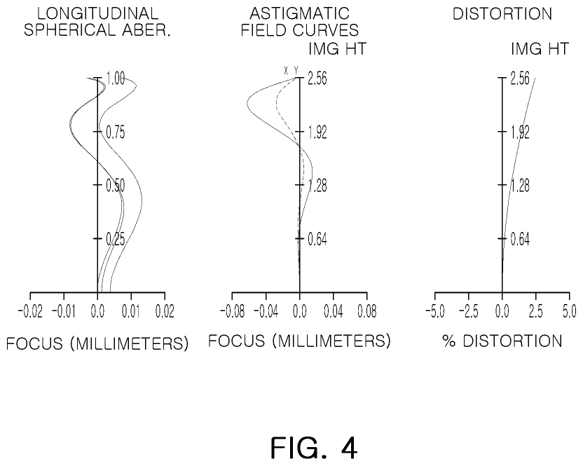

An example optical imaging system 200, in accordance with a second embodiment, will be described with reference to FIGS. 3 and 4.

The optical imaging system 200 according to the second embodiment includes a first lens group LG1 and a second lens group LG2. Additionally, the optical imaging system includes a reflective member P disposed between the first lens group LG1 and the second lens group LG2.

In order from the object side to the imaging plane, the first lens group includes a first lens 210 and a second lens 220, and the second lens group includes a third lens 230, a fourth lens 240, and a fifth lens 250.

Additionally, the optical imaging system may further include a filter IF and an image sensor.

The optical imaging system 200 according to the second embodiment may form a focus on an imaging plane IP. The imaging plane IP may refer to a surface on which a focus is formed by the optical imaging system. As an example, the imaging plane IP may refer to one surface of an image sensor that receives light.

In the second embodiment, the reflective member P may be a prism. However, this is only an example, and the reflective member P may also be provided as a mirror.

Lens characteristics of each lens (a radius of curvature, a thickness of a lens or a distance between lenses, a refractive index, an Abbe number, or an effective radius) are illustrated in Table 3 below.

TABLE 3

| | | | Radius of | Thickness | Refractive | Abbe | Effective |
|---|---|---|---|---|---|---|---|
| Component | Lens surface | Surface No. | Curvature | or Distance | Index | No. | Radius |
| 1st Lens | L1S1 | S1 | −12.768 | 0.423 | 1.535 | 55.7 | 3.150 |
| | L1S2 | S2 | −16.339 | 1.823 | | | 3.150 |
| 2nd Lens | L2S1 | S3 | −27.881 | 0.454 | 1.535 | 55.7 | 3.180 |
| | L2S2_R1 | S4 (reflection) | −15.792 | −0.454 | | | 3.190 |
| | L2S1 | S5 | −27.881 | −1.823 | | | 3.080 |
| 1st Lens | L1S2 | S6 | −16.339 | −0.423 | 1.535 | 55.7 | 2.143 |
| | L1S1_R2 | S7 (reflection) | −12.768 | 0.423 | | | 1.985 |
| | L1S2 | S8 | −16.339 | 1.823 | | | 1.971 |
| 2nd Lens | L2S1 | S9 | −27.881 | 0.454 | 1.535 | 55.7 | 1.755 |
| | L2S2 | S10 | −15.792 | 0.500 | | | 1.733 |
| Prism | PS1 | S11 | Infinity | 2.000 | 1.717 | 29.5 | 4.000 |
| | PS2 | S12(reflection) | Infinity | −2.000 | 1.717 | 29.5 | 4.000 |
| | PS3 | S13 | Infinity | −0.835 | | | 4.000 |
| 3rd Lens | L3S1 | S14 | −4.240 | −0.400 | 1.544 | 56.0 | 1.230 |
| | L3S2 | S15 | −3.625 | −0.500 | | | 1.280 |
| 4th Lens | L4S1 | S16 | −79.903 | −0.681 | 1.639 | 23.5 | 1.307 |
| | L4S2 | S17 | 2.834 | −0.369 | | | 1.320 |
| 5th Lens | L5S1 | S18 | 3.100 | −0.513 | 1.639 | 23.5 | 1.501 |
| | L5S2 | S19 | 16.709 | −8.000 | | | 1.498 |
| Filter | | S20 | Infinity | −0.210 | 1.5168 | 64.2 | |
| | | S21 | Infinity | −0.742 | | | |
| Imaging | | S22 | Infinity | | | | |
| Plane | | | | | | | |

The value described as the effective radius of the prism in Table 3 refers to the value of the major axis effective radius. In the second embodiment, the minor axis effective radius of the incident surface of the prism is 2 mm.

In the second embodiment, the first lens group LG1 may have an overall positive refractive power, and the second lens group LG2 may have an overall negative refractive power.

The first lens 210 may have negative refractive power, an object-side surface of the first lens 210 may have a concave shape, and an image-side surface of the first lens 210 may have a convex shape.

The second lens 220 may have positive refractive power, an object-side surface of the second lens 220 may have a concave shape, and an image-side surface of the second lens 220 may have a convex shape.

The third lens 230 may have positive refractive power, an object-side surface of the third lens 230 may have a concave shape, and an image-side surface of the third lens 230 may have a convex shape.

The fourth lens 240 may have negative refractive power, and an object-side surface and an image-side surface of the fourth lens 240 may be concave in shape.

The fifth lens 250 may have positive refractive power, an object-side surface of the fifth lens 250 may have a convex shape, and an image-side surface of the fifth lens 250 may have a concave shape.

In an example, each surface of the first lens 210 to the fifth lens 250 may have an aspherical coefficient as illustrated in Table 4 below. In an example, the object-side surface and the image-side surface of each of the first lens 210 to the fifth lens 250 may be aspherical.

TABLE 4

| | S1 | S2 | S3 | S4 | S5 | S6 | S7 | S8 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| Constant | | | | | | | | |
| (K) | | | | | | | | |
| 4th | −1.805E−05 | 3.827E−05 | −2.359E−05 | 1.050E−05 | −2.359E−05 | 3.827E−05 | −1.805E−05 | 3.827E−05 |
| Coefficient | | | | | | | | |
| (A) | | | | | | | | |
| 6th | −2.189E−08 | 6.256E−07 | 3.067E−07 | −1.566E−09 | 3.067E−07 | 6.256E−07 | −2.189E−08 | 6.256E−07 |
| coefficient | | | | | | | | |
| (B) | | | | | | | | |
| 8th | −1.642E−08 | 3.510E−08 | 3.690E−08 | −7.285E−09 | 3.690E−08 | 3.510E−08 | −1.642E−08 | 3.510E−08 |
| coefficient | | | | | | | | |
| (C) | | | | | | | | |
| 10th | −1.257E−09 | 2.403E−09 | −5.842E−10 | 2.089E−10 | −5.842E−10 | 2.403E−09 | −1.257E−09 | 2.403E−09 |
| coefficient | | | | | | | | |
| (D) | | | | | | | | |
| 12th | −2.774E−13 | −3.493E−10 | −6.599E−11 | −3.583E−11 | −6.599E−11 | −3.493E−10 | −2.774E−13 | −3.493E−10 |
| coefficient | | | | | | | | |
| (E) | | | | | | | | |
| 14th | −3.407E−13 | −5.259E−12 | −9.299E−12 | 1.587E−12 | −9.299E−12 | −5.259E−12 | −3.407E−13 | −5.259E−12 |
| coefficient | | | | | | | | |
| (F) | | | | | | | | |

| | S9 | S10 | S14 | S15 | S16 | S17 | S18 | S19 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| Constant | | | | | | | | |
| (K) | | | | | | | | |
| 4th | −2.359E−05 | 1.050E−05 | 2.015E−03 | −1.663E−03 | 1.017E−03 | 7.524E−04 | −2.232E−03 | 1.770E−03 |
| Coefficient | | | | | | | | |
| (A) | | | | | | | | |
| 6th | 3.067E−07 | −1.566E−09 | −4.197E−04 | 2.172E−04 | 5.269E−04 | −7.696E−04 | −1.623E−04 | 6.453E−04 |
| coefficient | | | | | | | | |
| (B) | | | | | | | | |
| 8th | 3.690E−08 | −7.285E−09 | −3.081E−04 | 3.096E−04 | 1.939E−04 | −4.805E−04 | 1.010E−04 | 1.364E−04 |
| coefficient | | | | | | | | |
| (C) | | | | | | | | |
| 10th | −5.842E−10 | 2.089E−10 | 9.296E−05 | 7.327E−05 | 1.147E−04 | −1.251E−04 | 9.842E−05 | 2.502E−05 |
| coefficient | | | | | | | | |
| (D) | | | | | | | | |
| 12th | −6.599E−11 | −3.583E−11 | 1.391E−04 | 8.236E−05 | 7.746E−06 | 1.427E−04 | 0.000E+00 | 8.438E−05 |
| coefficient | | | | | | | | |
| (E) | | | | | | | | |
| 14th | −9.299E−12 | 1.587E−12 | 0.000E+00 | 0.000E+00 | 0.000E+00 | 0.000E+00 | 0.000E+00 | −1.936E−05 |
| coefficient | | | | | | | | |
| (F) | | | | | | | | |

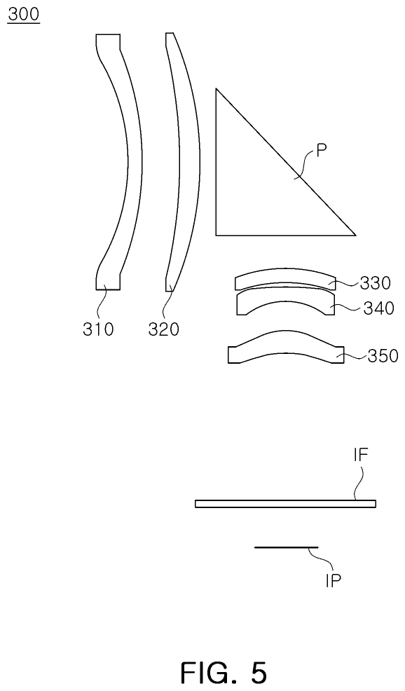

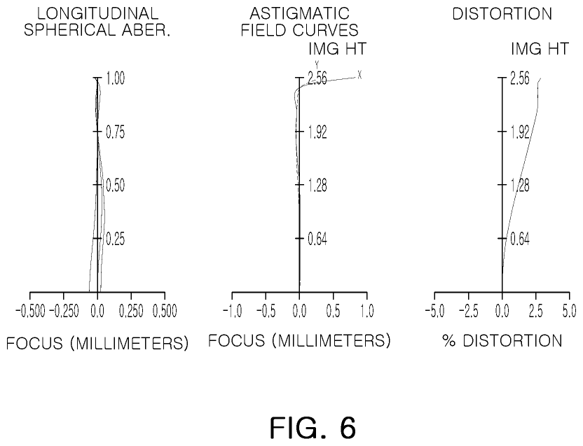

An example optical imaging system 300, in accordance with a third embodiment, will be described with reference to FIGS. 5 and 6.

The example optical imaging system 300 according to the third embodiment includes a first lens group LG1 and a second lens group LG2. Additionally, the optical imaging system includes a reflective member P disposed between the first lens group LG1 and the second lens group LG2.

In order from the object side to the imaging plane, the first lens group LG1 may include a first lens 310 and a second lens 320, and the second lens group may include a third lens 330, a fourth lens 340, and a fifth lens 350.

Additionally, the optical imaging system may further include a filter IF and an image sensor.

The optical imaging system 300 according to the third embodiment may form a focus on an imaging plane IP. The imaging plane IP may refer to a surface on which a focus is formed by the optical imaging system. As an example, the imaging plane IP may refer to one surface of an image sensor that receives light.

In the third embodiment, the reflective member P may be a prism. However, this is only an example, and the reflective member P may also be provided as a mirror.

Lens characteristics of each lens (a radius of curvature, a thickness of a lens or a distance between lenses, a refractive index, an Abbe number, or an effective radius) are illustrated in Table 5 below.

TABLE 5

| | Lens | | Radius of | Thickness | Refractive | Abbe | Effective |
|---|---|---|---|---|---|---|---|
| Component | surface | Surface No. | Curvature | or Distance | Index | No. | Radius |
| 1st Lens | L1S1 | S1 | −4.654 | 0.400 | 1.535 | 55.7 | 3.150 |
| | L1S2 | S2 | −5.939 | 1.079 | | | 3.150 |
| 2nd Lens | L2S1 | S3 | −13.094 | 0.566 | 1.535 | 55.7 | 3.180 |
| | L2S2_R1 | S4 (reflection) | −8.253 | −0.566 | | | 3.190 |
| | L2S1 | S5 | −13.094 | −1.079 | | | 2.993 |
| 1st Lens | L1S2 | S6 | −5.939 | −0.400 | 1.535 | 55.7 | 1.916 |
| | L1S1_R2 | S7 (reflection) | −4.654 | 0.400 | | | 1.640 |
| | L1S2 | S8 | −5.939 | 1.079 | | | 1.665 |
| 2nd Lens | L2S1 | S9 | −13.094 | 0.566 | 1.535 | 55.7 | 1.594 |
| | L2S2 | S10 | −8.253 | 0.450 | | | 1.597 |
| Prism | PS1 | S11 | Infinity | 2.000 | 1.717 | 29.5 | 4.000 |
| | PS2 | S12(reflection) | Infinity | −2.000 | 1.717 | 29.5 | 4.000 |
| | PS3 | S13 | Infinity | −0.900 | | | 4.000 |
| 3rd Lens | L3S1 | S14 | 14.070 | −0.400 | 1.544 | 56.0 | 1.300 |
| | L3S2 | S15 | 8.987 | −0.100 | | | 1.251 |
| 4th Lens | L4S1 | S16 | 8.188 | −0.400 | 1.639 | 23.5 | 1.251 |
| | L4S2 | S17 | 2.546 | −0.801 | | | 1.153 |
| 5th Lens | L5S1 | S18 | 1.869 | −0.599 | 1.639 | 23.5 | 1.450 |
| | L5S2 | S19 | 2.356 | −4.000 | | | 1.500 |
| Filter | | S20 | Infinity | −0.210 | 1.5168 | 64.2 | |
| | | S21 | Infinity | −1.085 | | | |
| Imaging | | S22 | Infinity | | | | |
| Plane | | | | | | | |

The value described as the effective radius of the prism in Table 5 refers to the value of the major axis effective radius. In the third embodiment, the minor axis effective radius of the incident surface of the prism is 2 mm.

In the third embodiment, the first lens group LG1 may have an overall positive refractive power, and the second lens group LG2 may have an overall negative refractive power.

The first lens 310 may have negative refractive power, an object-side surface of the first lens 310 may have a concave shape, and an image-side surface of the first lens 310 may have a convex shape.

The second lens 320 may have positive refractive power, an object-side surface of the second lens 320 may have a concave shape, and an image-side surface of the second lens 320 may have a convex shape.

The third lens 330 may have negative refractive power, an object-side surface of the third lens 330 may have a convex shape, and an image-side surface of the third lens 330 may have a concave shape.

The fourth lens 340 may have negative refractive power, an object-side surface of the fourth lens 340 may have a convex shape, and an image-side surface of the fourth lens 340 may have a concave shape.

The fifth lens 350 may have positive refractive power, an object-side surface of the fifth lens 350 may have a convex shape, and an image-side surface of the fifth lens 350 may have a concave shape.

In an example, each surface of the first lens 310 to the fifth lens 350 may have an aspherical coefficient as illustrated in Table 6 below. In an example, the object-side surface and the image-side surface of each of the first lens 310 to the fifth lens 350 may be aspherical.

TABLE 6

| | S1 | S2 | S3 | S4 | S5 | S6 | S7 | S8 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| Constant | | | | | | | | |
| (K) | | | | | | | | |
| 4th | 9.535E−04 | 7.742E−04 | −2.965E−04 | 1.007E−04 | −2.965E−04 | 7.742E−04 | 9.535E−04 | 7.742E−04 |
| Coefficient | | | | | | | | |
| (A) | | | | | | | | |
| 6th | 1.106E−04 | 8.251E−05 | 3.696E−06 | −1.097E−06 | 3.696E−06 | 8.251E−05 | 1.106E−04 | 8.251E−05 |
| coefficient | | | | | | | | |
| (B) | | | | | | | | |
| 8th | 7.620E−06 | 8.081E−06 | 5.600E−07 | −5.897E−08 | 5.600E−07 | 8.081E−06 | 7.620E−06 | 8.081E−06 |
| coefficient | | | | | | | | |
| (C) | | | | | | | | |
| 10th | 5.516E−07 | 4.233E−07 | 5.702E−08 | −1.819E−09 | 5.702E−08 | 4.233E−07 | 5.516E−07 | 4.233E−07 |
| coefficient | | | | | | | | |
| (D) | | | | | | | | |
| 12th | 1.964E−08 | 6.035E−09 | 4.650E−09 | 3.801E−10 | 4.650E−09 | 6.035E−09 | 1.964E−08 | 6.035E−09 |
| coefficient | | | | | | | | |
| (E) | | | | | | | | |
| 14th | −3.899E−09 | −1.160E−09 | 1.302E−10 | 1.239E−10 | 1.302E−10 | −1.160E−09 | −3.899E−09 | −1.160E−09 |
| coefficient | | | | | | | | |
| (F) | | | | | | | | |

| | S9 | S10 | S14 | S15 | S16 | S17 | S18 | S19 |
|---|---|---|---|---|---|---|---|---|
| Conic | 0.000E+00 | 0.000E+00 | 0.000E+00 | 0.000E+00 | 0.000E+00 | 0.000E+00 | 0.000E+00 | 0.000E+00 |
| Constant | | | | | | | | |
| (K) | | | | | | | | |
| 4th | −2.965E−04 | 1.007E−04 | 7.144E−02 | 1.885E−02 | 6.132E−03 | 5.971E−02 | −3.839E−02 | −4.131E−02 |
| Coefficient | | | | | | | | |
| (A) | | | | | | | | |
| 6th | 3.696E−06 | −1.097E−06 | −9.503E−03 | 1.461E−02 | 3.470E−03 | −9.507E−03 | −5.628E−03 | −1.675E−03 |
| coefficient | | | | | | | | |
| (B) | | | | | | | | |
| 8th | 5.600E−07 | −5.897E−08 | −2.025E−03 | 7.311E−04 | 3.996E−03 | −4.427E−03 | −8.126E−04 | −1.098E−03 |
| coefficient | | | | | | | | |
| (C) | | | | | | | | |
| 10th | 5.702E−08 | −1.819E−09 | 1.157E−03 | −2.021E−03 | 1.395E−03 | 4.061E−03 | −7.414E−04 | −4.394E−04 |
| coefficient | | | | | | | | |
| (D) | | | | | | | | |
| 12th | 4.650E−09 | 3.801E−10 | −6.248E−04 | −4.393E−04 | −7.545E−04 | 4.526E−04 | 0.000E+00 | 8.195E−06 |
| coefficient | | | | | | | | |
| (E) | | | | | | | | |
| 14th | 1.302E−10 | 1.239E−10 | 0.000E+00 | 0.000E+00 | 0.000E+00 | 0.000E+00 | 0.000E+00 | 2.858E−05 |
| coefficient | | | | | | | | |
| (F) | | | | | | | | |

TABLE 7

| | 1^{st} | 2^{nd} | 3^{rd} |
|---|---|---|---|
| | Embodiment | Embodiment | Embodiment |
| fT | 26.845 | 26.845 | 27.001 |
| f1 | −254.500 | −113.941 | −45.099 |
| f2 | −9.127 | −6.329 | −3.330 |
| f3 | −11.217 | −5.840 | −2.207 |
| f4 | 123.969 | 67.223 | 40.101 |
| f5 | −298.684 | 37.418 | −47.033 |
| f6 | −12.884 | −4.268 | −5.944 |
| f7 | 15.454 | 5.869 | 9.567 |
| f1G | 22.802 | 20.443 | 17.660 |
| f2G | −64.833 | −37.662 | −11.095 |
| IMG HT | 2.556 | 2.556 | 2.556 |
| Rs | −21.699 | −15.792 | −8.253 |
| Rp | −24.330 | −12.768 | −4.654 |
| Hs | 3.000 | 2.620 | 3.100 |
| Hp | 6.300 | 6.300 | 6.300 |
| L | 20.399 | 17.400 | 13.645 |
| Lf | 5.200 | 5.200 | 4.495 |
| Lr | 17.249 | 14.250 | 10.495 |
| d | 2.643 | 2.700 | 2.045 |
| Ph | 4.000 | 4.000 | 4.000 |
| TTL | 22.449 | 19.450 | 14.990 |
| BFL | 8.931 | 8.952 | 5.295 |

In Table 7, fT is a total focal length of the optical imaging system, f1 is a focal length of the first lens, f2 is a focal length of light reflected from the first reflective surface of the second lens, f3 is a focal length of light reflected from the second reflective surface of the first lens, f4 is a focal length of the second lens, f5 is a focal length of the third lens, f6 is a focal length of the fourth lens, and f7 is a focal length of the fifth lens.

f1G is a total focal length of the first lens group, and f2G is a total focal length of the second lens group.

IMG HT is half the diagonal length of the imaging plane, Rs is a radius of curvature of the second reflective surface of the first lens group, Rp is a radius of curvature of the first reflective surface of the first lens group, Hp is an effective diameter of the object-side surface of the first lens, and Hs is an effective diameter of the second reflective surface of the first lens.

L is a sum of a distance along the second optical axis from the third reflective surface of the reflective member to the imaging plane and an effective radius of the first lens, Lf is a distance along the first optical axis from the second reflective surface of the first lens group to the third reflective surface of the reflective member, and Lr is a distance along the second optical axis from the third reflective surface of the reflective member to the imaging plane.

d is a distance along the first optical axis from the object-side surface of the first lens to the image-side surface of the second lens, and Ph is a sum of a distance along the first optical axis from the incident surface of the reflective member to the reflective surface and a distance along the second optical axis from the reflective surface of the reflective member to the exit surface.

TTL is a sum of Lf and Lr, and BFL is a distance along the second optical axis from the image-surface of the rearmost lens of the second lens group to the imaging plane.

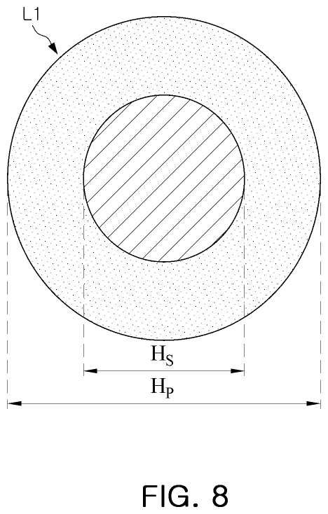

FIG. 8 illustrates a plan view of a first lens of an example optical imaging system. Hs represents a secondary mirror or diameter of the lens, and Hp represents a primary mirror or diameter of the lens.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical imaging system, comprising:
a first lens group, comprising a first lens and a second lens arranged along a first optical axis, and having at least two reflective surfaces;
a second lens group, comprising a plurality of lenses arranged along a second optical axis, and spaced apart from the first lens group; and
a reflective member disposed between the first lens group and the second lens group,
wherein the at least two reflective surfaces comprise a first reflective surface disposed on an image-side surface of the second lens, and a second reflective surface disposed on an object-side surface of the first lens,
wherein the object-side surface of the first lens comprises a first refractive surface that extends outwardly of the second reflective surface,
wherein the image-side surface of the second lens comprises a second refractive surface that is disposed inwardly of the first reflective surface,
wherein the reflective member comprises a third reflective surface, and
wherein a conditional expression f1G/fT<0.9 is satisfied, where f1G is a focal length of the first lens group, and fT is a total focal length of the optical imaging system.

2. The optical imaging system of claim 1, wherein the first lens group has positive refractive power, and the second lens group has negative refractive power.

3. The optical imaging system of claim 1, wherein a conditional expression f1G>0 and Rp<0 is satisfied, where Rp is a radius of curvature of the first reflective surface of the second lens of the first lens group.

4. The optical imaging system of claim 1, wherein a conditional expression 2 mm<d<3 mm is satisfied, where d is a distance along the first optical axis from the object-side surface of the first lens of the first lens group to the image-side surface of the second lens of the first lens group.

5. The optical imaging system of claim 1, wherein a conditional expression 0.2<|(2×d)/Rp|<0.6 is satisfied, where d is a distance along the first optical axis from the object-side surface of the first lens of the first lens group to the image-side surface of the second lens of the first lens group, and Rp is a radius of curvature of the first reflective surface of the second lens of the first lens group.

6. The optical imaging system of claim 1, wherein a conditional expression 0.4<Hs/Hp<0.6 is satisfied, where Hp is an effective diameter of the object-side surface of the first lens of the first lens group, and Hs is an effective diameter of the second reflective surface of the first lens of the first lens group.

7. The optical imaging system of claim 1, wherein the reflective member further comprises an incident surface and an exit surface, and the third reflective surface is disposed between the incident surface and the exit surface, and
wherein a conditional expression 0.4<d/Ph<0.8 is satisfied, where d is a distance along the first optical axis from the object-side surface of the first lens of the first lens group to the image-side surface of the second lens of the first lens group, and Ph is a sum of a distance along the first optical axis from the incident surface to the third reflective surface and a distance along the second optical axis from the third reflective surface to the exit surface.

8. The optical imaging system of claim 1, wherein a conditional expression L/fT<0.8 is satisfied, where Lis a sum of a distance along the second optical axis from the third reflective surface to an imaging plane disposed on the second optical axis and an effective radius of the first lens.

9. The optical imaging system of claim 1, wherein a conditional expression 0.5<Rs/Rp<1.3 is satisfied, where Rs is a radius of curvature of the second reflective surface of the first lens of the first lens group, and Rp is a radius of curvature of the first reflective surface of the second lens of the first lens group.

10. The optical imaging system of claim 1, wherein a conditional expression 1<f1G/Rp<2.3 is satisfied, where Rp is a radius of curvature of the first reflective surface of the second lens of the first lens group.

11. The optical imaging system of claim 1, wherein a conditional expression 0.1<Lf/fT<0.7 is satisfied, and Lf is a distance along the first optical axis from the second reflective surface of the first lens of the first lens group to the third reflective surface of the reflective member.

12. The optical imaging system of claim 1, wherein a conditional expression 0.2<Lf/Lr<0.5 is satisfied, where Lf is a distance along the first optical axis from the second reflective surface of the first lens of the first lens group to the third reflective surface of the reflective member, and Lr is a distance along the second optical axis from the third reflective surface of the reflective member to an imaging plane.

13. The optical imaging system of claim 1, wherein the first lens has negative refractive power, and the second lens has positive refractive power.

14. The optical imaging system of claim 1, wherein the plurality of lenses of the second lens group comprise a third lens, a fourth lens, and a fifth lens arranged along the second optical axis, and
wherein the fifth lens has positive refractive power.
